(19) United States
(12) Patent Application Publication
(10) Pub. No.: US 2007/0236582 A1
(43) Pub. Date: Oct. 11, 2007

(54) Video camera with multiple independent outputs

(75) Inventors: Kenneth D. Romano, Webster, NY (US); Anthony Frumusa, Penfield, NY (US); William A. Cook, Pittsford, NY (US); Samuel D. Ambalavanar, Rochester, NY (US); Michael E. Meyers, Fairport, NY (US); John S. Ceci, Penfield, NY (US); Robert M. Chapin, Rushville, NY (US); Mehdi Mansoori, Rochester, NY (US); Joseph Grassi, Webster, NY (US)

Correspondence Address: BERNHARD P. MOLLDREM, JR., 224 HARRISON STREET, SUITE 200, SYRACUSE, NY, 13202, US

(73) Assignee: Imaging Solutions Group of NY, Inc.

(21) Appl. No.: 11/391,987

(22) Filed: Mar. 29, 2006

(51) Int. Cl. H04N 5/76

(52) U.S. Cl. 348/231.99

(57) ABSTRACT

A multiple output video camera employs a multi-tap memory access system, in which an image input DMA master writes frames of a source image at a maximum frame rate and maximum resolution, via an image bus and a memory controller, into an image memory. In the multi-tap multiple access memory system, a plurality of concurrent independent video output circuits, each possess an image bus input/output master coupled to the image bus; an independent video signal processing circuit; and an output circuit that provides an independently processed version of the sequential video images to a respective output port. The outputs can be digital or analog.

### BACKGROUND OF THE INVENTION

This invention relates to a digital video camera, and is more particularly directed to a digital video camera incorporating means to deliver multiple independent video output signals based on the sequential video source images provided from a video imager.

Current state-of-the-art digital video cameras produce a video output as a sequence of video images in a single selected format. If multiple versions of the video picture are needed, the conventional approach is to employ a number of independent cameras to provide separate output signals. Alternatively, the video signal can be split, and one or more legs of the split video signal can be sent through a post-processing computer to convert it into a different format. This has been found to be rather cumbersome, costly, and limited in flexibility.

Various needs have arisen for cameras that can provide multiple outputs, or outputs in a number of formats for the same video signal. For example, in a security surveillance environment, it is often useful to provide the same video image both to a local monitor, e.g., as an NTSC signal, and also to remote viewing stations via an ethernet or other network, e.g., as a compressed digital video signal. Also in a security surveillance environment it is often desirable to view a portion of an overall scene from a single camera; e.g., where a surveillance camera provides a view of an entire parking lot on one monitor, it is often desirable for a security operator to zoom to a small portion of that scene, e.g., a single vehicle, on another monitor. However, no system of multiple independent output channels has been available in any digital video camera.

### OBJECTS AND SUMMARY OF THE INVENTION

Accordingly, it is an object of this invention to provide an improved digital video camera that avoids the drawbacks present in the prior art.

It is another object to provide a digital video camera that incorporates multiple independent output channels capable of providing various versions of the sequence of video images in different respective formats.

It is a further object to provide a video camera with multiple independent output channels that can be easily controlled to produce the desired output signals.

It is still a further object to provide a digital video camera that incorporates the hardware for producing the multiple independent outputs within the camera housing, and preferably on a single integrated circuit device.

In accordance with one aspect of the present invention, multiple independent video image output signals are provided based on a video signal that is in the form of a sequence of video images emanating from a single video sensor in the video camera, the sequence of images representing a scene captured by the digital video camera. This involves a predetermined number of the sequential video image frames in a video memory unit, e.g., three (or more) successive frames in a rolling memory. The camera accesses the video images stored in the video memory unit and provides the video images in parallel to two or more independent video output processing circuits. The video images in these independent output processing circuits are separately processed to provide respective independently formatted video output signals, and these output signals are provided at respective output ports.

A memory controller regulates the storage of the sequential images in the video memory unit, and also regulates the accessing of the stored video images that are provided to the output processing circuits.

The independent output processing circuits can carry out digital panning of a portion of the sequential images, and produce a sweeping view across the overall image. In one of the independent output processing circuits the processing can include digital zooming to enlarge a portion of the sequential images. The independent output processing circuits can format the video output signal into a standard analog interface format, e.g., PAL or NTSC, or as a standard digital interface format for networking. The various independently formatted video output signals are provided concurrently. The video output signals can be provided at different respective frame rates.

In a preferred embodiment, the accessing of the sequential video images and processing the video images are achieved with a multi-tap DMA based high-speed memory integrated circuit. The sequential video images from the video camera are written into the video memory unit at a maximum frame rate and maximum resolution of the camera. The storing of the above-mentioned sequential video source images in the video memory unit can favorably be carried out employing the video memory unit as a rolling buffer storing, e.g., three frames.

According to another aspect of this invention, a preferred embodiment of the multiple output video camera arrangement is built from a combination of an image sensor, a plurality of independent video output ports, a multi-tap memory access system, and an image memory device. The image sensor forms and captures an image of a target and produces a video signal as sequential frames of digital video images. The image memory stores a sequence of a predetermined number of those sequential frames as stored sequential digital images.

The multi-tap multiple access memory system includes an image input master having an input coupled to said image sensor means for receiving said sequential video image, and an output; a multi-master image bus coupled to the output of the image input master; a bus arbiter; a memory controller coupled to the image bus and to the image memory; and a plurality of concurrent independent video output circuits, each output circuit including an image bus input/output master coupled to the image bus; an independent video signal processing circuit; and an output circuit that provides an independently processed version of the sequential video images to a respective one of the independent output ports.

Favorably, the concurrent independent video output circuits each include a digital pan and zoom engine, and each include an output image processing circuit that produces its respective video signal at an independent frame rate. One or more of the output image processing circuits can be capable of providing the sequential video signal in a standard analog output format, and one or more can be capable of providing the sequential video signal in a standard digital output format.

In favorable embodiments, the camera's image sensor produces the source images as sequential frames of digital video images at a maximum frame rate and a maximum resolution, and the image input master places these sequential frames of the digital video source image into the image memory. The video frames of said sequential images are written into the image memory at the maximum frame rate and at the maximum resolution. The image memory can be configured as a rolling buffer storing three frames (or another number of frames) of sequential digital video images.

The above and many other objects, features, and advantages of this invention will present themselves to persons skilled in this art from the ensuing description of preferred embodiments of this invention, as described with reference to the accompanying Drawing.

### BRIEF DESCRIPTION OF THE DRAWING

FIG. 1 is a perspective view of a video camera according to one embodiment.

FIG. 2 is a schematic showing the general connectivity of the electronic elements of this embodiment.

FIGS. 3 and 4 are examples of images of a scene as viewed with the camera of this embodiment.

FIG. 5 is a block schematic explaining the architecture of this embodiment.

FIG. 6 is a chart explaining multiple-independent-channel processing of video images in this embodiment.

FIG. 7 is an overall system diagram of a camera embodying this invention.

### DETAILED DESCRIPTION OF THE PREFERRED EMBODIMENT(S)

With reference to the Drawing, FIG. 1 is a perspective view of a basic video camera 10, which can be used as a remote camera for surveillance or security, or can be used for video conferencing, for industrial machine vision, or for any other of a wide range of purposes. The camera 10 has a case or housing 12 with a lens group 14 on a front thereof for forming an image of a target or scene, and a number of output terminals, here including a pair of network or ethernet ports 18, and a pair of standard video terminals 20.

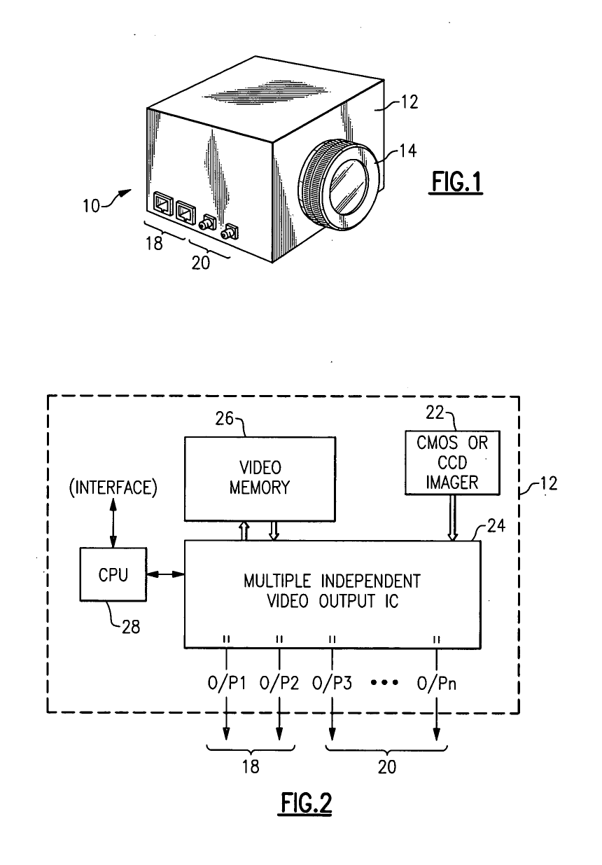

The basic electrical components and internal connectivity of the camera 10 is shown in FIG. 2. Here, the case or housing 12 is represented in dash lines, and contains an imager chip 22 that is disposed on a focal plane of the lens group 14, and this feeds an input video signal to a multiple-independent-channel video output IC 24, which is discussed in detail later. A video memory unit 26 capable of storing a number of successive frames of video in digital form from the imager 22 is connected to a memory port of the IC 24, and a number of independent video output ports O/P1, /P2 . . . O/Pn emanate from the IC and lead to one or another of the output ports or terminals 18, 20, etc. A controller or CPU 28 interfaces to receive commands to select and manipulate the video signals being processed on one or more of the channels in the IC 24 to they can provide respective different independently formatted view, and can represent different portions of the entire video image captured on the video imager 22.

The camera 10 can be employed e.g. as a networked camera with one or more independent local monitor outputs. That is, the camera 10 can send raw or compressed (JPEG) images to a remote computer (via port(s) 18), or to a computer monitor (in VGA or DVI format, for example) for local display, or can supply an independent television signal (NTSC, PAL, or HDMI, e.g.) for a local video monitor.

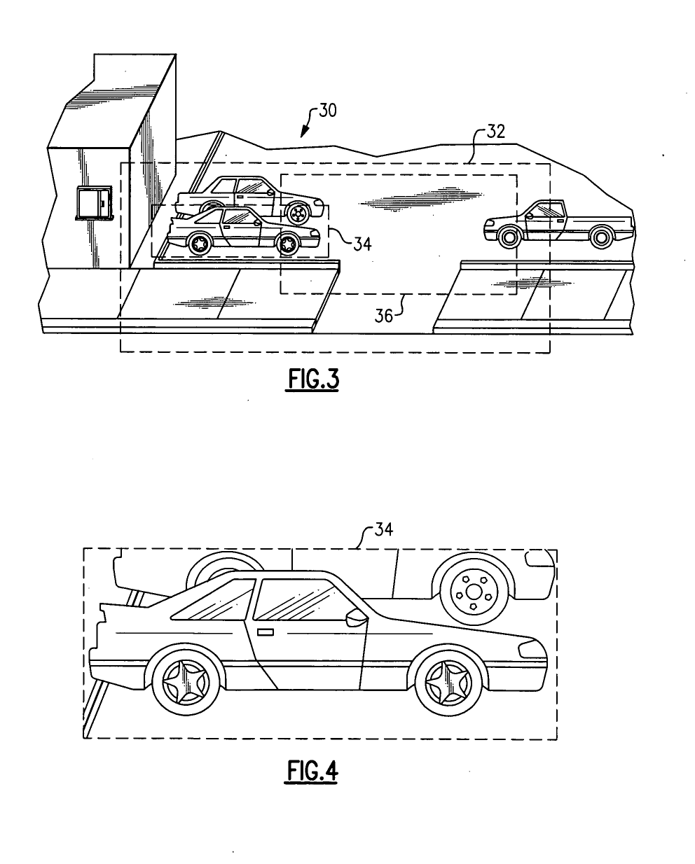

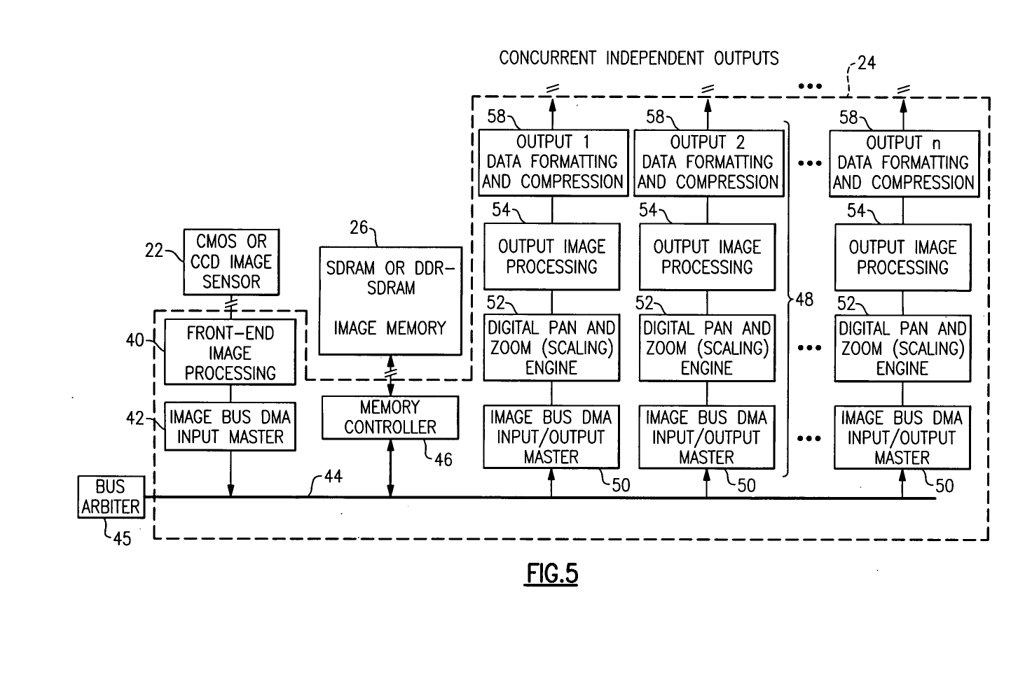

An example of one application of the camera 10 in a security surveillance environment can be explained with reference to FIGS. 3 and 4. Here, the camera is mounted to view a parking lot holding numerous parked cars, as shown in the overall scene 30 as viewed by the camera. The images of the entire scene 30 or of portions of it are available to a security operator, and the entire image or portions of it can be formatted independently for transmission to another monitor, to a video recorder, or over a network to a remote station. Here, one view of the scene is a wide area scene 32 that can be applied from one output terminal of the camera 10 to a video monitor or recorder. In practice, this can constitute the source image. A portion of the scene of interest, e.g., enlarged to display a single vehicle is represented as view 34, and this view 34 can be applied to another security monitor. This gives the security operator the capability of viewing a portion of the overall scene when he or she notices something suspicious, or in need of possible investigation. A third view 36 is shown here as including the entrance/exitway to the parking lot, and may be separately monitored or recorded, e.g., to monitor license plate numbers if that is called for. Each image portion is called up as needed and can be adjusted and formatted independently. It is also possible for the security operator to pan the image portion of view 34 across the parking lot from one side to the other, or to zoom in or out for a narrower or wider view.

Other possible applications would include a single-camera teleconference, in which the faces of attendees can be captured in separate image portions across a wider full conference view.

The video formats can be changed as need be, e.g., for frame rate, density, or other factors.

The system architecture of the multiple independent output channel IC 24 is shown as a block schematic in FIG. 5. Here the image sensor or imager chip 22 and the video memory unit or image memory unit 26 are standard components, that is a CCD or CMOS imager for the image sensor 22 and a standard SDRAM or DDR-SDRAM for the image memory unit 26. The remaining elements shown in FIG. 5 belonging to the IC 24 are incorporated into the same integrated circuit, and this may be implemented in an ASIC (application-specific integrated circuit) or an FPGA (field-programmable gate array) which functionally comprises an ASIC that can be programmed in the field, i.e., by a stored program in a RAM that configures the FPGA at start up. The blocks identified in FIG. 5 are designated as custom blocks in this implementation.

Within the multiple independent output channel IC 24, a front-end image processing circuit 40 receives the incoming video signal from the imager 22, and converts it to the proper levels and format for digital processing. Image processing is applied on every frame of source video data from the image sensor 22. An input bus direct memory access (DMA) input master circuit module 42 directs the access to the video or image memory 26. The DMA input master 42 connects to a high speed video bus 44 that supplies an input port of a memory controller 46. A bus arbiter 45 is associated with the video bus 44. The memory controller allows multi-master concurrent, time-multiplexed access into the image memory 26 by utilizing the bus arbiter 45. The controller manages access by all image bus DMA masters, as discussed later. This high-speed concurrent access is achieved because of the high speed of the memory 26 and the memory access, burst transfer, and a first-in-first-out (FIFO) scheme in the DMA masters.

As also shown in FIG. 5, the IC 24 also includes a number of independent output processing circuits or output channel(s) 48, each of which has a respective bus DMA input/output master 50 coupled to the common video bus 44. Each independent processing circuit or output channel 48 is a series of modules capable of providing a video output signal in any of a number of formats. In each channel 48, the DMA master directs access to the video memory via the memory controller 46. A digital pan and zoom engine 52 controls the region of interest in the source image that the particular output channel accesses. This circuit also provides scaling and zooming (i.e., reduction and enlargement) via a multi-tap scaler block. An output image processing module 54 provides custom image processing as required on each individual output channel. A data formatting and compression circuit 58 provides formatting to allow the video data being applied to the respective output to be converted or altered to match the specifications of required output devices. This circuit module 58 can be employed for converting the output signal to a standard such as ethernet, 1394, NTSC, or PAL. This module 58 can also be used for data compression, e.g., to convert to JPEG. Module 58 provides the video output signal at the desired format and frame rate to the video output O/P1, O/P2, . . . O/Pn.

The key to implementation of the multiple independent outputs of the camera is the methodology employed in management of the image memory system. The frames of the source image, as received from the sensor 22, are written into the video memory 26 at the sensor's maximum resolution and fastest frame rate. A rolling buffer of three frames is stored.

At one output channel 48, the DMA master 50 accesses into the stored frames from above at any region of interest and between any starting and ending pixels to capture the desired image for the particular respective output from that channel.

At a second output channel, the DMA master 50 access into the same stored frames from above and from any starting pixel to capture the desired image for the second channel. The second channel is entirely independent of the first.

Likewise, a third, fourth, and further independent outputs can be obtained for third, fourth, etc. independent output channels. There may be as few as two channels in some implementations, and there may be six or more in other implementations.

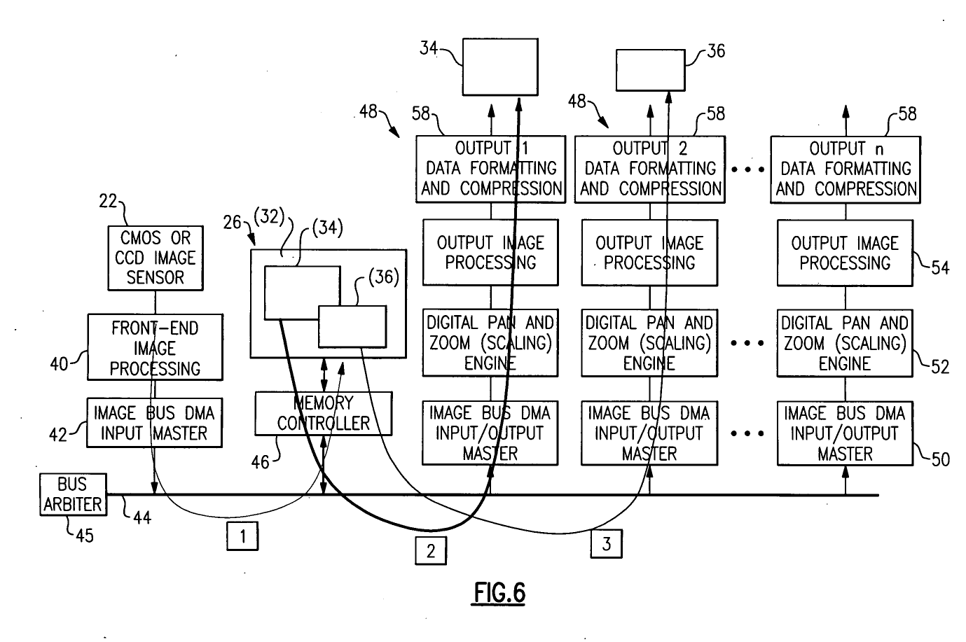

The functionality of the multiple-access video memory and multiple independent channel processing can be explained with reference to the diagram as shown in FIG. 6, where the elements are the same as those shown in FIG. 5 and as described herein above. Here, two channels O/P1 and O/P2 are utilized to view different portions of the overall viewing area of the camera.

The images captured by the camera on the sensor 22 are processed on front-end image processing circuit 40 and the image frames are written into the image memory 26 at maximum resolution and frame rate, via input master 42, image bus 44 and memory controller 46. This process is represented by the source image input pathway [1]. The source image data stored on the memory 26 represent the larger video scene 32 (e.g., as in FIG. 3). Here, the different rectangles within the block representing the image memory 26 can indicate different regions within the frame buffer where each output channel can be “looking”, i.e., the different rectangles represent respective portions of the source image. One output video image, e.g., scene of interest 34, has an output pathway [2] involves a involving one output channel 48, whose DMA master 50 accesses into the frames from above to select the region of interest (scene 34) and the output channel produces the desired images of scene 34. A second output video image (e.g., view 36 of FIG. 3) has an output pathway represented as pathway [3]. Here a second one of the independent output channels 48 accesses into the stored frames from above at its respective region of interest to output the desired image of scene 36 at its respective output. Each of these output paths operates completely independent of the other. The two output video signals can be differently formatted with different frame rates, as well as covering different portions of overall scene 32.

Additional independent output video signals can be produced concurrently.

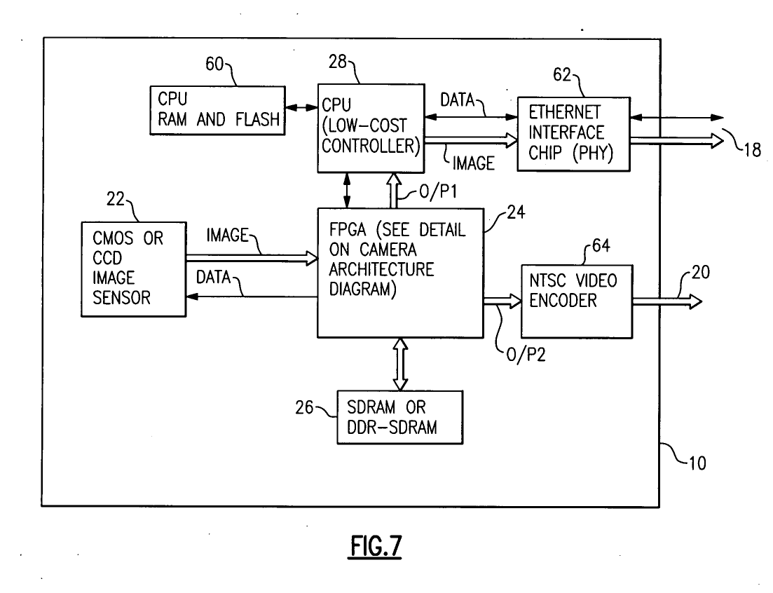

FIG. 7 is a higher-level block diagram for explaining integration of the camera 10 into a multiple output network system. Here, as a simple example, the camera is shown with one channel connected to a network output 18 and one channel connected to a video output 20. Image/data buses are represented by hatched lines, and control signal or message channels are represented by solid black lines. The elements discussed previously are identified with the same reference numbers, and are not described again in detail. Here, the CPU 28, which can be implemented with a low cost controller IC, is placed in line with one output channel O/P1 and is connected with a RAM and Flash memory 60, which stores the required programming. The CPU 28 is then coupled via a data bus and a signal channel to an ethernet interface IC 62, which couples to output port 18. This provides a network video output to feed a remote station, and also allows an attendant at the remote station to send control signals upstream to change, select, or sweep the images provided to the remote station.

A second output O/P2 goes to an NTSC video encoder 64, which provides a standard television signal output to the video output 20. This can be connected with a local monitor, e.g., for aiming and adjusting the camera during set up, or for routine field maintenance. More outputs can be provided, but only two are shown here for reasons of simplicity.

Many other applications of this multiple independent output camera exist, and the camera is certainly not limited only to security surveillance. For example, the camera can be used in a conference setting for a video conference call, where the independent image portions could be faces of the persons attending the conference. The camera can also be used in a machine vision or automation environment, where images and image portions can be used to check the quality of products on a line or belt. Many other possibilities will present themselves.

While the invention has been described and illustrated in respect to a few selected preferred embodiments, it should be appreciated that the invention is not limited only to those precise embodiments. Rather, many modifications and variations would be apparent to those of skill in the art without departing from the scope and spirit of this invention, as defined in the appended claims.

We Claim:

1. Process for providing multiple independent video image output signals from a single video sensor in which a video camera captures a scene and produces a video signal comprising sequential digital video images, the process comprising:
Storing a sequence of a predetermined number of said sequential video images in a video memory unit;
Accessing the video images in said video memory unit and providing said video images in parallel to two or more independent video output processing circuits; and
Processing the video images in each of said output processing circuits to provide respective independently formatted video output signals to a plurality of video output ports.

2. The process of claim 1 wherein a memory controller regulates the storage of said sequential images in said video memory and regulates the accessing of said video images that are provided to said output processing circuits.

3. The process of claim 1 wherein the processing in at least one of said independent output processing circuits includes digital panning of a portion of said sequential images.

4. The process of claim 1 wherein the processing in at least one of said independent output processing circuits includes digital zooming to enlarge a portion of said sequential images.

5. The process of claim 1 wherein the processing in at least one of said independent output processing circuits includes formatting the video output signal into a standard analog interface format.

6. The process of claim 1 wherein the processing in at least one of said independent output processing circuits includes formatting the video output signal into a standard digital interface format.

7. The process of claim 1 wherein said independently formatted video output signals are provided concurrently.

8. The process of claim 1 wherein said independently formatted video output signals are provided at different respective frame rates.

9. The process of claim 1 wherein said step of accessing the sequential video images and processing the video images are achieved employing a multi-tap DMA based high-speed memory integrated circuit.

10. The process of claim 1 wherein said sequential video images from said video camera are written into the video memory unit at a maximum frame rate and maximum resolution of said camera.

11. The process of claim 1 wherein the step of storing a predetermined number of said sequential video images in the video memory unit includes employing said video memory unit as a rolling buffer storing three or more frames of said video images.

12. A multiple output video camera arrangement comprising:
Image sensor means for forming and capturing an image of a target and producing a video signal as sequential frames of digital video images;
An image memory for storing a sequence of a predetermined number of frames of said sequential images;
A multi-tap multiple access memory system which includes
An image input master having an input coupled to said image sensor means for receiving said sequential video image, and an output;
A multi-master image bus coupled to the output of said image input master;
A memory controller coupled to said image bus and to said image memory; and
A plurality of concurrent independent video output circuits, each including an image bus master coupled to said image bus; an independent video signal processing circuit; and an output circuit portion providing an independently processed version of said sequential video images to a respective independent output port.

13. The camera arrangement according to claim 12 wherein said concurrent independent video output circuits each include a digital pan and zoom engine.

14. The camera arrangement according to claim 12 wherein said concurrent independent video output circuits each include an output image processing circuit for providing the sequential video signal at a respective independent frame rate.

15. The camera arrangement according to claim 14 wherein one of said output image processing circuits provides the sequential video signal in a standard analog output format.

16. The camera arrangement according to claim 14 wherein one of said output image processing circuits provides the sequential video signal in a standard digital output format.

17. The camera arrangement according to claim 12 wherein said image sensor provides the sequential frames of digital video images of said video signal at a maximum frame rate and a maximum resolution, and said image input master provides said sequential frames of the digital video image to said image memory so that said predetermined number of frames of said sequential images are written into said image memory at said maximum frame rate and at said maximum resolution.

18. The camera arrangement according to claim 12 wherein said image memory is configured as a rolling buffer storing three or more frames of said sequential images.
